(19) United States
(12) Patent Application Publication
(10) Pub. No.: US 2012/0059697 A1
(43) Pub. Date: Mar. 8, 2012

(54) ADVERTISING DURING ACCELERATED MEDIA PLAYBACK

(75) Inventors: Jeffrey Y. Lin, Seattle, WA (US); Ione Fine, Seattle, WA (US); Geoffrey M. Boynton, Seattle, WA (US); Scott O. Murray, Lake Forest Park, WA (US)

(73) Assignee: UNIVERSITY OF WASHINGTON, Seattle, WA (US)

(21) Appl. No.: 13/319,382

(22) PCT Filed: May 7, 2010
(86) PCT No.: PCT/US2010/034113

§ 371 Date: Nov. 8, 2011

Related U.S. Application Data
(60) Provisional application No. 61/176,708, filed on May 8, 2009.
(60) Provisional application No. 61/261,283, filed on Nov. 13, 2009.

(51) Int. Cl. G06Q 30/02

(52) U.S. Cl. 705/14.4

(57) ABSTRACT

A system and a method are disclosed for displaying an image during an operation of an accelerated media playback (e.g., fast-forward or reverse) such that the image appears concurrently with a cue signaling a resume point. First, a video frame within an advertisement is identified from a plurality of advertisements. The video frame contains the cue and indicates a resume point for media content. Additionally, an image is embedded on the video frame such that the video frame, the cue and the image are displayed for less than a second during accelerated media playback, such as a fast-forward operation. The presence of the action cue or resume cue presented concurrently with the advertisement assists viewers in preferentially recalling the product related to the image.

### CROSS REFERENCE TO RELATED APPLICATIONS

This application claims the benefit of U.S. Provisional Application No. 61/176,708, filed May 9, 2009, which is incorporated by reference in its entirety.

This application claims the benefit of U.S. Provisional Application No. 61/261,283, filed Nov. 13, 2009, which is incorporated by reference in its entirety.

### STATEMENT OF GOVERNMENT INTEREST

This application was made with Government support under Contract Number RO1 EY12925 awarded by the National Institutes of Health (NIH). The Government has certain rights to this invention.

### BACKGROUND

1. Field of Art

The disclosure generally relates to the field of advertisement during media playback.

2. Description of the Related Art

Placing advertisements within media content is a common practice. Television has become the preferred medium for mass-market advertising because it reaches many viewers across a broad or particular demographic. Thus, advertisers often purchase particular timeslots from either a television network or a broadcaster to advertise their products based on a target audience. The networks and the broadcasters base their fees on the number of perceived viewers watching the television content at the particular time slot. Thus, the more viewers a particular television show can attract, the higher the fees the networks and the broadcasters can charge for the advertisement (“ad”) timeslot for a broadcast program.

Digital video recorders (DVRs), and the use of DVRs to record media content for a later playback has become commonplace. DVRs allow viewers to maneuver anywhere within a recorded portion of a television show. Using that capability, a viewer can skip over advertisement (or commercial) breaks in television shows. Many viewers have already adapted such ad-avoidance methods either by pre-recording television shows, or by delaying the viewing of a live television show by 15 minutes. This 15 minute lag enables the viewer to have enough of the television show recorded ahead of the viewing position to skip all advertisement breaks within a one-hour television show. The advent of DVRs and the consequent ad-avoidance behavior by viewers has reduced the number of viewers viewing advertisements. As a consequence, advertisers are seeking discounts from networks and local broadcasters who generate and broadcast media content. Networks and the local broadcasters are facing downward pressure to lower advertisement prices because of advertisers' demands. Alternatively, advertisers may demand discounts for each advertisement fast-forwarded by the viewer. In either case, the networks and the local broadcasters are generating lower advertisement revenue per viewer as more viewers adopt ad-avoidance strategies.

One method to overcome ad-avoidance behaviors is to display a pop-up static image advertisement if a user fast-forwards through an advertising segment. However, such methods are very invasive and unpopular since DVR customers generally purchase a DVR service and a system to avoid such pop-up advertisements. Additionally, such static images block the underlying fast-forwarding content, thereby preventing a user from knowing when to resume normal playback. Consequently, such methods of advertising provide an unsatisfactory user experience. Finally, such static pop-up image ads have proved to be less effective in affecting user behavior than video television advertisements.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one embodiment of an operating system for displaying advertisement content during accelerated media playback.

FIG. 2 illustrates one embodiment of a Digital Video Recorder (DVR) used in presenting advertisement content during accelerated media playback.

FIG. 3 illustrates one embodiment of an advertisement engine responsible for rendering advertisement content during an accelerated media playback operation.

FIG. 4 illustrates one embodiment of a method for presenting advertisement content in an accelerated media playback operation.

FIG. 5 illustrates an image of a user interface displaying advertisement content during an accelerated media playback operation.

FIG. 6 illustrates an embodiment for displaying multiple enhanced advertisement images within one advertisement block.

### DETAILED DESCRIPTION

The Figures (FIGS.) and the following description relate to preferred embodiments by way of illustration only. It should be noted from the following discussion that alternative embodiments of the structures and methods disclosed herein will be readily recognized as viable alternatives. Thus, alternative embodiments may be employed without departing from the principles of what is claimed.

Reference will now be made in detail to several embodiments, examples of which are illustrated in the accompanying figures. It is noted that wherever practicable, similar or like reference numbers are used in the figures and indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments of a disclosed system seek to display an image or video during an operation of an accelerated media playback (e.g., fast forward or reverse) such that the image appears concurrently with a cue signaling a resume or action point whereupon an action by the viewer will cause the desired media content to resume. Presenting the image paired with a cue signaling the beginning of the media content or a viewer action point for normal playback assists viewers in preferentially recalling the product related to the image.

The co-occurrence of the image and the resume or action cue during accelerated media playback enhances the memory recall of products associated with the displayed image. Additionally, a viewer whose memory has thus been enhanced may be more likely to preferentially choose or purchase the advertised product as compared to a competitive or similar product. The enhanced memory recall of the products associated with the co-occurrence of an image and a resume or action cue may provide significant advantages to an advertiser in a landscape where more users are adopting ad-avoidance behaviors described above. Thus the disclosed method and system present a more effective way to advertise during accelerated media playback when compared to methods known in the art.

In one embodiment, the image and the cue are presented only during an accelerated playback operation. The image is presented by displaying the image with a resume or action cue. The cue may include one or more audible, visual or tactile cues, which are recognizably distinguished by a viewer of the media content during accelerated playback. The resume or action cue may advise viewers to perform a certain action to stop accelerated playback and resume normal playback or simply inform viewers that their desired media content is about to resume. The resume or action cue may be presented by displaying the cue as an image within the accelerated media content. The cue may also be presented by playing a sound or by providing a tactile feedback associated with one or more advertisement video frames displayed at an accelerated playback speed. By way of example, a broadcast program that has been recorded includes one or more primary portions and one or more secondary portions. The primary portions correspond to the primary broadcast that was recorded, for example, a television show, a sports event, a movie, or a reality show. The secondary portion comprises an advertisement block. The advertisement block may contain one or more messages, e.g., one or more advertisements or information, which are separate from the primary portion.

Continuing with the example, media content is received and stored by a DVR. In one embodiment, a video frame within the received media content is associated with a resume or action cue. In the embodiment, the resume or action cue represents a resume point indicating the resumption of the primary media content. In such an embodiment, once an accelerated media playback is determined, the system searches for one or more video frames paired with the cue and stored in the DVR. Once the one or more video frames paired with a cue are identified, the system selects an image and embeds the image with each one or more video frames. The one or more video frames are outputted to the viewer concurrently with the embedded image and the paired cue for less than a second during accelerated media playback.

### System Architecture

FIG. (FIG. 1 illustrates an example system according to an embodiment. The system contains a digital video recorder (“DVR”) 102 which is communicatively coupled to network 105 through any communications interface, such as an Ethernet interface or wireless communications port. The functionality of a DVR 102 is described in greater detail below. The system also includes service provider 104, content provider 106, personal computer 108 and portable device 110.

Personal computer 108 may be a personal computing device, such as a desktop computer or laptop computer, and is also coupled to network 105 through any communications interface, including wireless. Portable device 110 may be any handheld computing device, cellular phone, portable media player, or any other portable device capable of displaying multimedia content and is also coupled to network 105 through any communications interface, including wireless. DVR 102, personal computer 108, and portable device 110 each communicate with service provider 104 through network 105. In another embodiment, DVR 102, personal computer 108, and portable device 110 each communicate with content provider 110 through network 105.

Network 105 may be implemented by any medium or mechanism that provides for the exchange of data between devices in the communication system. Examples of network 105 include, without limitation, a network such as a Local Area Network (LAN), Wide Area Network (WAN), the Internet, one or more terrestrial, satellite or wireless links, etc. Alternatively or additionally, any number of devices connected to network 105 may also be directly connected to each other through a communications link.

In one embodiment, content provider 106 provides broadcast program content to DVR 102 via cable, satellite, terrestrial communication, or other transmission method. Broadcast program content may include any multimedia content such as: audio, image, or video content. In another embodiment, content provider 106 provides multimedia content, such as any downloadable content, through network 105 to DVR 102, personal computer 108, or portable device 110.

In one embodiment, DVR 102 communicates with service provider 104, which provides program guide data, graphical resources (such as fonts, pictures, etc.), service information, software, advertisements, event identification data, and other forms of data that enable DVR 102 to operate independently of service provider 104 to satisfy user interests. In another embodiment, DVR 102, personal computer 108, and portable device 110 can communicate with each other to transfer content, metadata, or any other data through network 105 or any local network.

In another embodiment, content provider 106 may provide, to service provider 104, content data or any metadata, including promotional data, icons, web data, and other information. Service provider 104 may then interpret the metadata and provide the content data and metadata to DVR 102, personal computer 108, or portable device 110.

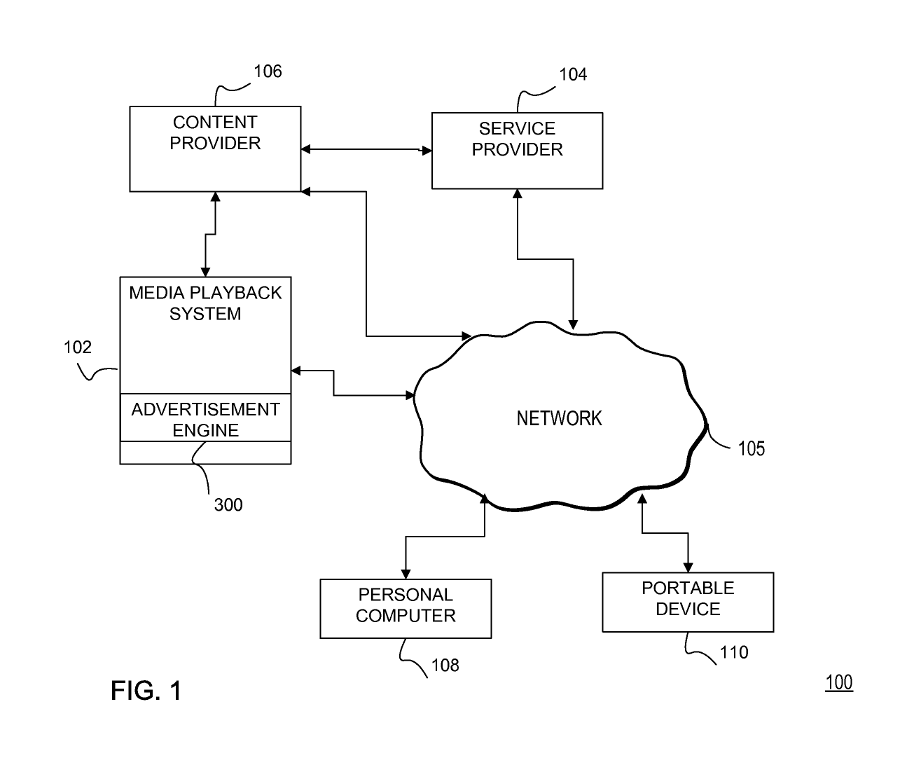

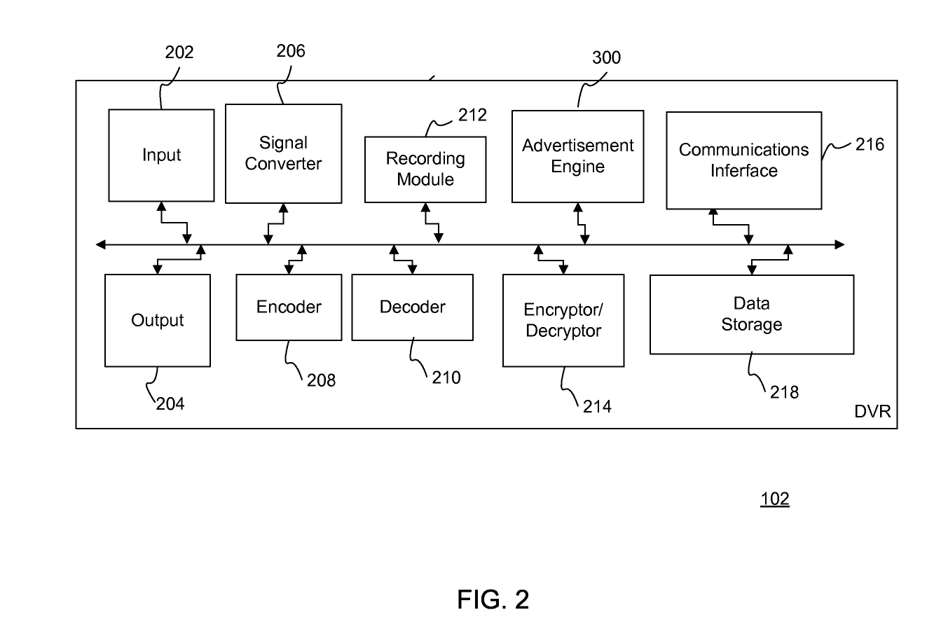

Referring to FIG. 2, in an embodiment, DVR 102 generally comprises a plurality of components, signified by signal converter 206, that are necessary to digitize an analog television signal and convert it into a digital data stream or accept a digital data stream. DVR 102 receives broadcast signals from an antenna, from a cable TV system, satellite receiver, etc., via input 202. Input 202 may comprise a plurality of tuning modules that allow a plurality of signals to be received and recorded simultaneously.

Recording module 212 records the incoming data stream by storing the digital data stream on at least one storage facility, signified by storage 218 that is designed to retain segments of the digital data stream. A signal converter 206 retrieves segments of the data stream, convert the data stream into an analog signal, and then modulate the signal onto a radio-frequency (RF) carrier, via output 204, through which the signal is delivered to a standard television (TV) set, via an antenna input, cable input, etc. Signal converter 206 can also convert the data stream into an analog signal for output via output 204 to composite input, S-video input, etc., to a TV set or monitor. Output 204 may alternatively deliver a digital signal to a TV set or video monitor. For example, DVR 102 may utilize a Digital Visual Interface port (DVI) for sending digital signals to a TV via a DVI cable or DVR 102 may utilize a High-Definition Multimedia Interface port (HDMI) for sending digital signals to a TV via a HDMI cable. A portable DVR or media player can utilize an internal display screen and optionally deliver a digital or analog signal to a TV set or video monitor via output 204.

DVR 102 also includes a communication interface 216, through which the DVR 102 communicates with network 105 via Ethernet, wireless network, modem, or other communications standard. Further, DVR 102 may be integrated into a TV system such that the components described above are housed in a TV set capable of performing the functions of each component of DVR 102.

In another embodiment, DVR 102 generally comprises a plurality of components necessary to receive, record, store, transfer and playback digital data signals from a plurality of sources, such as a PC, a DVR, a service provider, or content server. DVR 102 can transfer digital data signals to another DVR or PC. DVR 102 may encode or decode digital signals via encoder 208 and decoder 210 into a plurality of formats for playback, storage or transfer. DVR 102 can also encrypt or decrypt digital data signals using encryptor/decryptor 214 for storage, transfer or playback of the digital data signals.

In one embodiment, DVR 102 communicates with service provider 103, which provides program guide data, graphical resources such as brand icons and pictures, service information, software programs, advertisements, and other forms of data that enable DVR 102 to operate independently of the service provider 104 to perform autonomous recording functions. Communication between DVR 102 and service provider 104 utilizes a secure distribution architecture to transfer data between the DVR 102 and the service provider 104 such that both the service data and the user's privacy are protected.

### Configuration for Enhanced Advertisement

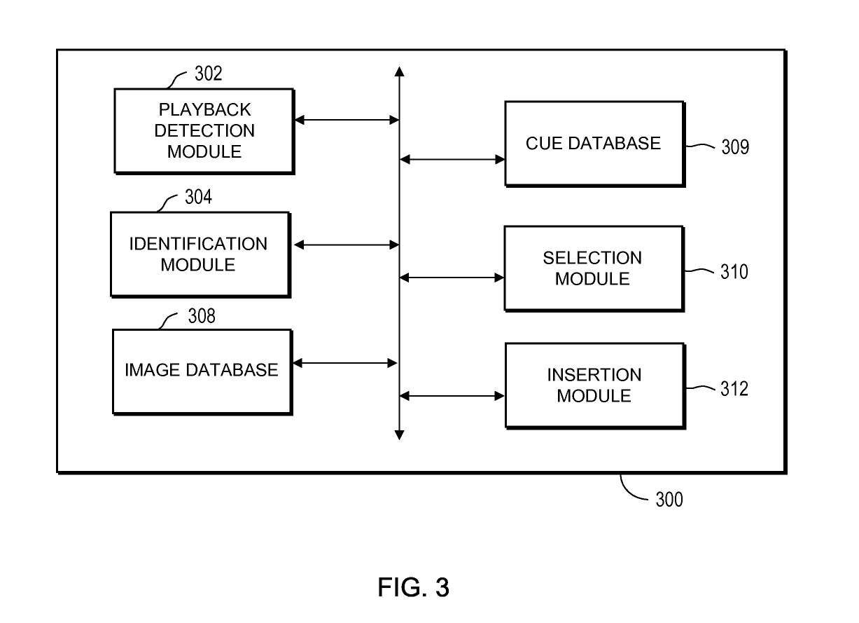

Referring now to FIG. 3, it illustrates an embodiment of an advertising engine 300. The advertising engine 300 is illustrated as a high level block diagram of modules configured to insert an image during an accelerated media playback. Upon reviewing the descriptions herein, those of skill in the art will recognize that other embodiments can have different and/or other modules than the ones described here, and that the functionalities can be distributed among the modules in a different manner. The advertising engine 300 includes a playback detection module 302, an identification module 304, an image database 308, a cue database 309, a selection module 310 and an insertion module 312. The modules are configured to function and communicatively couple (or interoperate) as described herein.

The advertising engine 300 includes a playback detection module 302 to determine the playback speed (e.g., for fast forward or for reverse) of a recorded video. If a user command to accelerate the playback speed of the media playback is received by a DVR 102, the playback detection module 302 is notified. In one embodiment, the playback detection module 302 determines an accelerated media playback by retrieving data from the communications interface 216. In another embodiment, the communications interface 216 notifies the playback detection module 302 when media is being displayed at an accelerated rate, such as in a fast-forward or a rewind operation. Upon detecting an accelerated playback operation, the playback detection module 302 initializes the other modules in the advertising engine 300. In another embodiment, the advertising engine 300 is only activated when the communications interface 216 determines an accelerated media playback operation.

In one embodiment, a cue integrated with media content is obtained by the advertising engine 300; the cue and the media content being transmitted by a content provider 106 or service provider 104. A cue is an image, sound or tactile feedback designed to attract the attention of a viewer. A cue notifies the viewer that a resume point is approaching or that the resume point has been reached. A resume point is any point that a service provider 104, content provider 106 or advertiser has chosen as a recommended resume point for normal playback. In a fast-forward operation, for example, the resume point is at the end of the advertisement block and before the resumption of the non-advertisement content.

In another embodiment, a cue data service integrates a cue object with selected media content prior to transmission of the selected media content to a DVR 102. A cue may be pre-announced such that a viewer may be actively anticipating the cue or it may be displayed without any forewarning. For example, a cue may be a green square on the middle of a video frame indicating a resume point. In other embodiments, a cue may include one or more audible, visual or tactile cues or a combination thereof, which are recognizably distinguished by a viewer of the media content during playback. Examples of audible cues may include, but are not limited to, specific words, phrases, tones, languages and sounds of a particular pitch, frequency, volume or duration. Examples of visual cues may include, but are not limited to alpha-numeric characters, specific images of people, places and/or things or objects of varying color, brightness, contrast, pattern, visual texture and hue. Examples of tactile cues may include, but are not limited to, vibration, pressure or temperature.

The identification module 304 identifies the video frame within which to embed an image. In one embodiment, the service provider 104 or the content provider 106 identifies a predetermined advertisement to display an image. In another embodiment, the content provider 106 or service provider 104 identifies a last advertisement within a plurality of advertisements in an advertisement block to display an image. In one embodiment, the service provider 104 or content provider 106 also identifies a video frame within the identified advertisement to embed an image. In another embodiment, the identification module 304 identifies a last video frame of a last advertisement in an advertisement block as the video frame to embed an image. In another embodiment, the content provider 106 or service provider 104 may provide that media content associated with a particular time stamp be displayed with a cue and an image during accelerated playback. For example, video frames with a nine o'clock PM timestamp may be identified by the identification module 304 to embed an image if played back in an accelerated operation. The embedding steps are described in greater detail below.

In one embodiment, the service provider 104, the content provider 106 or an advertiser identifies a particular video frame to embed an image and presents a resume cue concurrent with that video frame. In an embodiment where the cue is an image, the identification module 304 performs an image analysis search for a video frame displayed with a cue within the digital media content stored on a DVR 102. For example, if a cue is a green colored square box displayed in the middle of a video frame, the identification module 304 searches the video frames stored on a DVR 102 until a video frame with a green colored square box is found. In an embodiment where the cue is a sound or a tactile feedback, the identification module 304 performs a metadata search to find a video frame associated with the sound or the tactile feedback. If the identification module 304 finds such a video frame, it flags the video frame to embed an image as described in reference to the insertion module 312 below.

In another embodiment, an advertiser provides a video frame to embed an image. In such an embodiment, the identification module 304 uses image analysis techniques to match the provided video frame with a video frame within the video frames stored on a DVR. For example, an image matching program may be used to find a stored video frame that matches a video frame provided by an advertiser, service provider 104 or content provider 106. An image matching program may compare the signal functions or rendering functions of the two video frames to determine if an array of pixels of the stored video frame is similar to the array of pixels in the provided video frame. If there is a match, the identification module 304 identifies the video frame to embed an image.

The selection module 310 selects at least one image to display with a video frame identified by the identification module 304. In one embodiment, the selection module 310 selects an image to display on a video frame from an image database 308. An image database 308 is a table of images stored on a DVR 102. In one embodiment, images are provided by a service provider 104, a content provider 106 or an advertiser over a network 105 and stored in the image database 308. In another embodiment, the DVR 102 retrieves an image over a network 105 to download images to the image database 308.

The selection module 310 selects at least one image to display with a video frame identified by the identification module 304. In another embodiment, an image provided by a service provider 104, content provider 106 or advertiser is selected to pair with a particular video frame identified by the identification module 304. In another embodiment, the selection module 310 finds an image stored in the image database 308 which is behaviorally relevant to the underlying advertisement. A behaviorally relevant image is one that enhances a viewer's memory of the advertised content or reinforces a certain aspect of the product advertised to make a product more memorable to a viewer.

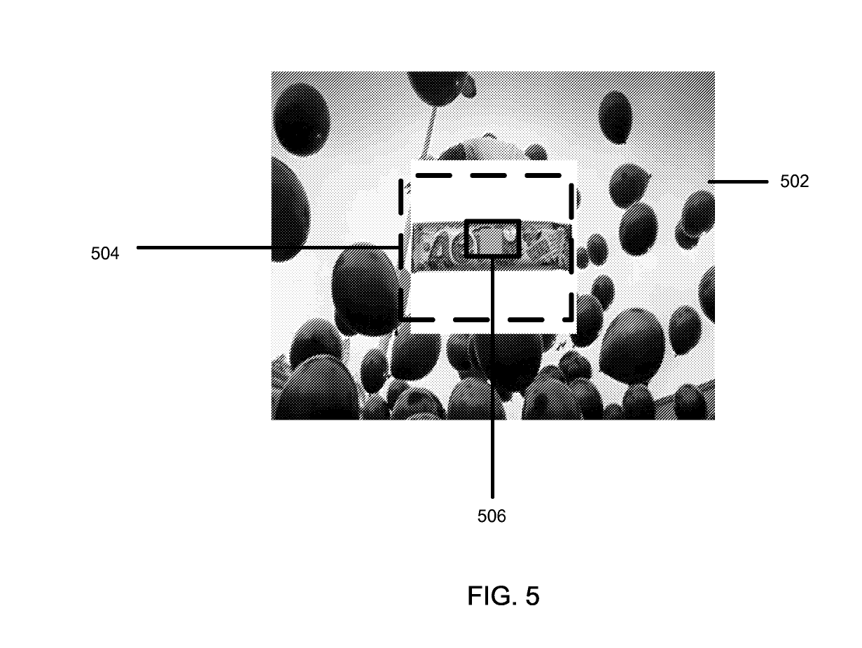

The insertion module 312 embeds the image selected by the selection module 310 onto a video frame identified by the identification module 304. In another embodiment the insertion module 312 embeds the image on more than one video frame wherein each frame is immediately before or after the frame identified by the identification module 304, such that the image is displayed for less than a second in the accelerated playback operation. By presenting the cue and the image concurrently during accelerated media playback, the user's memory recall of the image or the product associated with the image may be enhanced. An exemplary embodiment of the image and the cue is shown in FIG. 5 and discussed in further detail below.

In an embodiment, where a cue is not provided with the media content, the advertising engine 300 attaches a cue and an image to a particular video frame stored on a DVR 102. In such an embodiment, an advertiser, a service provider 104 or a content provider 106 provides a video frame to embed an image and a cue. The identification module 304 finds such a video frame stored on a DVR 102. The selection module 310 selects a cue from a cue database 309 to present with a video frame identified by the identification module 304. Additionally, the selection module 310 selects an image from an image database 308 to display with a video frame identified by the identification module 304. Finally, the insertion module 312 embeds the image and the cue with the identified video frame to present the video frame, the cue and the image to the viewer during an accelerated media playback. The presentation of the cue concurrently with an image may assist the viewer in preferentially recalling the image or the product associated with the image among the totality of media content presented to the user. Thus, by co-occurrence of the media content, the image and the resume or action point cue, the memory recall of the image or the product associated with the image may be enhanced.

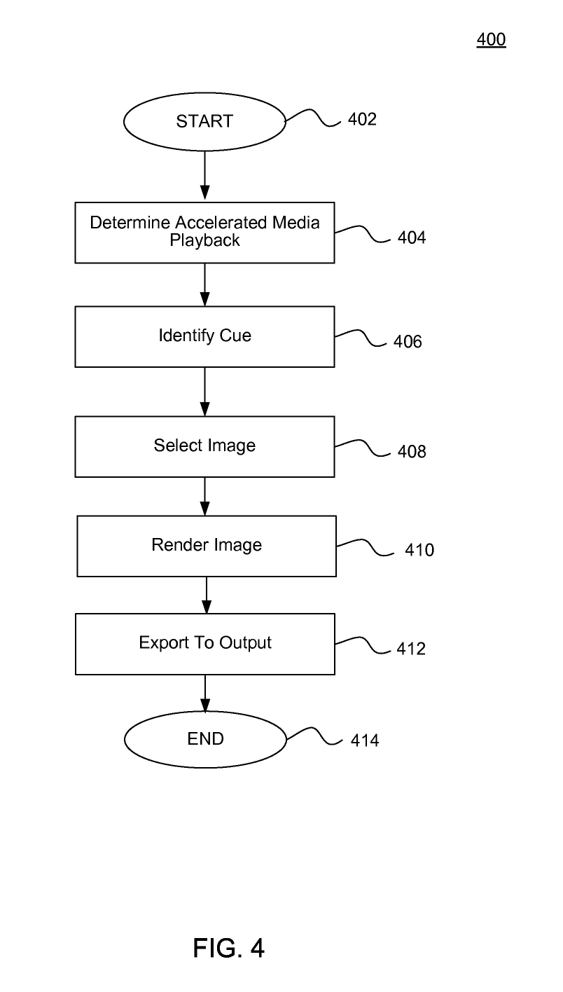

FIG. 4 is a flow chart illustrating the operation of the advertising engine 300 according to one embodiment. The process starts 402 once accelerated media playback is determined 404. Once accelerated playback is determined, the process identifies a cue 406 paired with media content stored on the DVR 102. Additionally, the process selects an image 408 from the image database corresponding to the underlying advertisement. The selected image is embedded on the identified video frame comprising the cue 410. Finally, the identified video frame, the cue and the embedded image are displayed to the viewer 412 through the video output 204 on a DVR 102.

Initially, the enhanced advertising process starts 402 on the advertising engine 300; the process determines an accelerated playback 404 operation such as fast-forward or rewind. In one embodiment, the process determines an accelerated playback 404 by communicating with a communications interface 216 of the DVR 102. In other embodiments other components, such as video output 204 may also be used to determine an accelerated playback operation 404.

Once accelerated playback is determined 404, the process scans the video frames stored on the DVR 102 to find a cue. In one embodiment, where a fast-forward playback operation is determined, the process successively scans video frames to be displayed next. In an embodiment where a cue is an image, an image analysis is applied to each frame to determine which video frame comprises an embedded cue. In an embodiment where a cue is a sound or a tactile feedback, a metadata search is performed to find the cue paired with a particular video frame stored on a DVR 102. In another embodiment, a service provider 104, a content provider 106 or an advertiser may not provide a video frame with a cue. However, a video frame appearing prior to a resume point may be provided. In such an embodiment, the process performs an image analysis on each frame to be displayed and stored on the DVR 102. Once a stored video frame matches a provided video frame, the video frame is selected for the embedding steps described below.

Continuing with the process 400, an image is selected to display on the identified video frame. In one embodiment, an image stored in an image database 308 is selected to embed in the identified video frame. In one embodiment, the image is provided by a service provider 104, a content provider 106 or an advertiser. In one embodiment the image is provided over a network 105. In another embodiment, the image is provided over a network 105 and stored in the image database 308. In another embodiment an image which is behaviorally relevant to the underlying advertisement is selected. A behaviorally relevant image is one which is likely to enhance a viewer's memory of the advertised product.

The process continues by rendering 410 the selected image on the video frame. In one embodiment, the image is rendered using a method known in the arts such as rasterization, ray casting, radiosity or ray tracing. In another embodiment the image is superimposed over the video frame. In an embodiment where a cue is not provided with a video frame, both a cue and an image are rendered on the video frame using a method known in the art.

Referring now to FIG. 5, it illustrates a video frame 502 comprising an image 504 and a cue 506. As described in one embodiment of process 400, a video frame 502 with a cue 506 is provided by a service provider 104, content provider 106 or an advertiser. Once an accelerated playback operation is determined, the process scans the video frames stored on the DVR 102 to find a video frame 502 with a cue 506. An image 504 is retrieved from either an image database 308 or over a network 105. As shown in FIG. 5, an AERO candy bar image 504 is embedded within the video frame 502 and displayed with a cue 506 during an accelerated playback operation.

Referring again to FIG. 4, once an image is rendered on the selected video frame, the process exports 412 the video frame to display the rendered video frame. In one embodiment, the rendered video frame is exported to a video output 204 on a DVR 102 to output to a connected television or a display device. In one embodiment, the rendered video frame is placed in a succession of video frames for output 204. In another embodiment, the rendered video frame is encoded with a succession of video frames prior to being output to a connected display unit. The process ends 414 once the rendered frame is exported to the appropriate modules on the DVR 102 for output to a display.

### Multiple Enhanced Advertisements

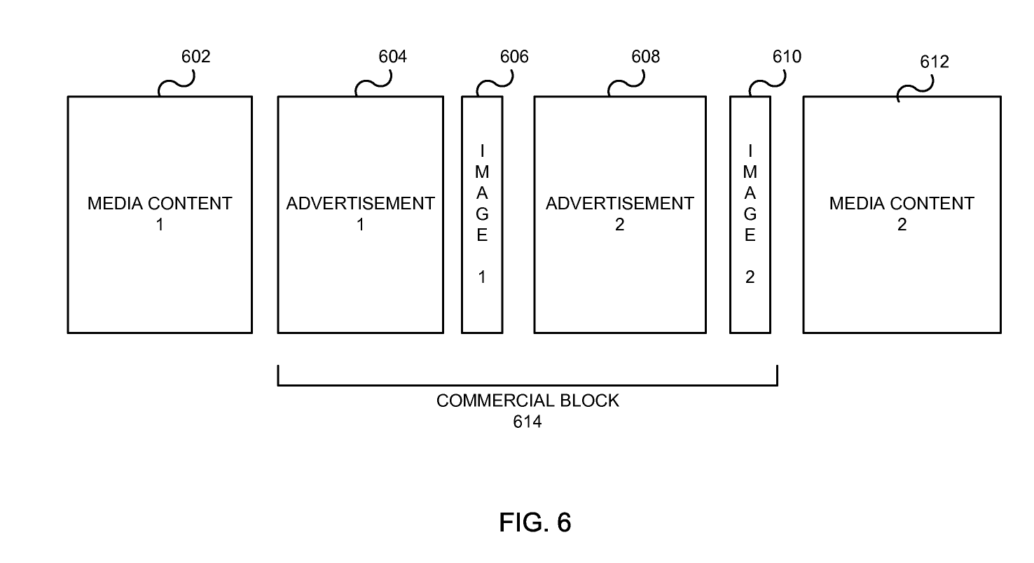

Referring now to FIG. 6, it illustrates an embodiment for displaying multiple enhanced advertisement images within one advertisement block. The disclosed embodiments beneficially allow for skipping one or more advertisements while providing an enhanced advertisement image, to enhance recall of the advertised product. FIG. 6 illustrates media content 602, 612, such as a television show, advertisements 604, 608 and enhanced advertisement images 606, 612. Advertisement 1, 604 to image 2, 610 is comprises a advertisement block 614.

In one embodiment, instead of a cue indicating a resume point for non-advertisement content, the cue indicates a skip point. A skip point communicates to a viewer that an advertisement can be skipped entirely by performing a particular command. A skip point, thus allows a viewer to skip advertised content and reach non-advertisement content more efficiently. For example, if a fast forward operation is detected during a DVR playback, then the system will search for a video frame with an embedded cue 606. Once the video frame 606 is reached during the fast-forward operation it is displayed to the viewer.

In one embodiment, a cue notifying the viewer of a skip point and a cue notifying the viewer of a resume point are different. For example, cues notifying the viewer of a skip point maybe red in color, while cues resume point in a advertisement block 614 may be green. Thus, when the system or process 400 described above, does a video frame analysis in response to an accelerated playback, if the process finds a video frame with a red cue, presence of a skip point is communicated to the viewer. If however, the process 400 finds a green cue, presence of a resume point is communicated to the viewer. Other embodiments may differentiate cues not only by color, but by sound or by the shape of the cue.

Thus, in the embodiment above, once a viewer is presented with a video frame with a skip point 606, the process 400 continues a video frame analysis until the next cue embedded within a video frame is found. If for example, the user executes a command indicating a skip operation, the DVR skips to the next video frame with a cue 610.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with FIGS. 1, 2 and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods (for example, as illustrated and described with FIGS. 3, 4 and 6) described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for embedding an image within a pre-identified video frame and displaying the image in an accelerated media playback operation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for providing an image during an operation of an accelerated media playback, the method comprising:
identifying a advertisement within plurality of advertisements in an advertisement block of media playback content, the identified advertisement provided with a cue and prior to a resume point for normal playback;
selecting an image, the image associated with the identified advertisement and separate from the identified advertisement;
embedding the image associated with the identified advertisement; and
providing the advertisement, the cue and the image for less than a second during the accelerated media playback.

2. The method of claim 1, wherein the accelerated media playback comprises one of a fast forward operation and a reverse operation.

3. The method of claim 1, wherein the resume point corresponds to an end of an advertisement in the fast forward operation.

4. The method of claim 1, further comprising:
generating a cue notifying the viewer of a resume point within a plurality of advertisements in the advertisement block;
inserting the cue prior to the resume point.

5. The method of claim 1, wherein the cue comprises an object presented with a last frame of the plurality of frames.

6. A method for providing an image during media playback, the method comprising:
identifying one or more advertisements within a plurality of advertisements in an advertisement block of media playback content, each advertisement provided with a cue at an acceleration point, each cue notifying the viewer of an acceleration point within a plurality of advertisements in the advertisement block;
selecting an image, the image associated with each identified advertisement and separate from the identified advertisement;
embedding the image associated with the identified advertisement within the cue; and
providing the image concurrently with the cue for less than a second during media playback.

7. The method of claim 6, wherein the acceleration point corresponds to an end of an advertisement in a forward playback operation.

8. The method of claim 6, further comprising:
generating a cue notifying the viewer of an acceleration point within the plurality of advertisements in the advertisement block; and
inserting the cue at the acceleration point.

9. The method of claim 8, wherein the cue comprises an object provided with a last frame within a plurality of frames of an advertisement.

10. A system for presenting an image during an operation of an accelerated media playback, the system comprising:
a hardware-implement identification module to identify an advertisement within plurality of advertisements in an advertisement block of media playback content, the identified advertisement provided with a cue and prior to a resume point for normal playback;
a hardware-implemented selection module to select an image, the image associated with the identified advertisement and separate from the identified advertisement;
a hardware-implement association module to embed the image associated with the identified advertisement; and
a hardware-implemented presentation module to present the advertisement, the cue and the image for less than a second during the accelerated media playback.

11. The system of claim 10, further comprising:
a hardware-implemented media playback module capable of presenting media in a fast forward operation and a reverse operation.

12. The system of claim 10, wherein the hardware-implemented identification module identifies a resume point based on a time stamp associated with an advertisement or based on an image analysis of an advertisement.

13. The system of claim 10, further comprising:
a hardware-implemented cue generation module to generate a cue indicating a resume point within a plurality of advertisements in the advertisement block;
a hardware-implemented cue insertion module to insert the cue prior to the resume point.

14. The system of claim 10, wherein the cue insertion module inserts a cue within a last frame of an advertising block.
